(19) United States
(12) Patent Application Publication
(10) Pub. No.: US 2026/0065384 A1
(43) Pub. Date: Mar. 5, 2026

(54) METHOD FOR CONFIGURATION OF ACCESS CONTROL TO POWER SUPPLY

(71) Applicant: HARTING Electric Stiftung & Co. KG, Espelkamp (DE)

(72) Inventors: Markus FRIESEN, Espelkamp (DE); Dmytro GRAKOV, Espelkamp (DE)

(73) Assignee: HARTING Electric Stiftung & Co. KG, Espelkamp (DE)

(21) Appl. No.: 19/108,272

(22) PCT Filed: Sep. 12, 2023
(86) PCT No.: PCT/DE2023/100675

§ 371 Date: Mar. 3, 2025

(30) Foreign Application Priority Data
Sep. 30, 2022 (DE) 10 2022 125 259.0

(51) Int. Cl. G06Q 50/06; G06Q 10/063

(52) U.S. Cl. CPC G06Q 50/06; G06Q 10/063

(57) ABSTRACT

In order to grant permission to at least one electrical device to be supplied with power and/or withdraw this authorization from it, according to the invention, a teach-in method is used.

### DESCRIPTION

The invention proceeds from a generic method according to independent claim 1.

Methods of this type are necessary for the communication to a power supply facility of which electrical devices are to be supplied with power, and which other devices are to be excluded from the power supply.

### PRIOR ART

Published document DE 10 2013 010 823 A1 addresses the general issue of the employment of different AC voltages and frequencies by AC power sockets in different regions of the world.

In order to prevent the inadvertent plugging of external device plugs having incompatible power supply units into AC power sockets, the scanning of a device plug identification tag, which can be inserted in a socket, is disclosed. The socket can be capable of outputting domestic or industrial high voltages. Electric power data for a device can be scanned from the device plug identification tag. Electric power data can indicate that the device contains a universal power supply unit. A controller can compare data thus received with a list of devices which are compatible with the available power supply. The power supply of the device can be activated or deactivated, according to the results of this comparison.

On the basis hereof, published document DE 10 2015 009 361 A1 proposes an intelligent socket, also described as a “smart socket”.

To this end, this published document further discloses that the plug connector of the electrical device which is to be plugged into the socket unit is equipped with a radio tag, on which data with respect to the device type of the electrical device which is to be connected to the intelligent socket are saved. The radio tag can be a RFID transponder or NFC (near field communication) transponder.

It is further disclosed that the smart socket is provided with a scanner device which, to this effect, enables communication between the radio tag and the scanner device when the plug connector is plugged in, that the scanner device captures a signal containing modeled data with respect to the device type of the electrical device which is plugged into the socket from the radio tag thereof, in a contactless manner, which signal is transmitted to a remote data processing device.

The disadvantage of these known systems is that no sufficiently uncomplex method is available by means of which an entitlement can be communicated to, and also withdrawn from, an authorized user for the isolation of electrical devices, using simple means.

In the context of the priority-claiming application regarding the present application, the German Patent and Trademark Office has researched the following prior art: DE 10 2015, 009 361 A1, DE 20 2010 011 660 U1, EP 2 234 075 A1 and Alfen ICU B.V. ; Eve Double Pro-line DE, Manual.

### DEFINITION OF OBJECT

The object of the invention is the disclosure of a method, by means of which a communication and/or withdrawal of an authorization for a supply of power to electrical devices is enabled, using the simplest possible means.

This object is fulfilled by a method according to independent claim 1.

The method is a “teach-in” method.

Advantageous configurations of the invention are disclosed in the sub-claims, and in the following description.

By the term “teach-in” method, in the present context, it is to be understood that, in one process step, an electrical device is selected, i.e. “identified” and, in a further process step, the authorization status of this device for the supply of power thereto is established manually, and is communicated to the power supply facility. This authorization status can be described as “authorized” or “not authorized”. In the case of an “authorized” authorization status, the electrical device, immediately it is connected to the power supply facility in an electrically conductive manner, is supplied with electrical energy by the power supply facility. In the case of a “not authorized” authorization status, the respective electrical device is not supplied with electrical energy by the power supply facility, even if it is electrically connected to the power supply facility.

In one potential configuration, the device selection according to the first-mentioned process step can be executed temporally in advance of authorization status communication according to the second-mentioned process step. However, compliance with this sequence is not absolutely necessary. In practice, this sequence can also be inverted, such that the above-mentioned authorization status communication to the power supply facility is executed first, and the assignment thereof to the relevant electrical device is only executed thereafter.

In a preferred embodiment, the electrical device can comprise a plug connector. The plug connector can incorporate a radio tag which carries a device ID (“identification”), e.g. a RFID tag (“radio frequency identification”), in particular a NFC tag (“near field communication”). This radio tag, in accordance with its function, is described hereinafter as an ID radio tag.

A mating plug connector which is appropriate to the plug connector can comprise a receiver antenna, e.g. a RFID reader antenna, in particular a NFC reader antenna. The power supply facility, in particular the mating plug connector of the power supply facility, can further incorporate a scanner device, e.g. a RFID reader, in particular a NFC reader. In the power supply facility, in particular in the scanner device, a database can be logged, in which the access authorization of individual electrical devices is saved, e.g. in the form of a table, in which the associated authorization status (“authorized”/“not authorized”) is assigned to the respective device ID.

The above-mentioned selection of the electrical device can thus be executed by plugging the plug connector of the electrical device into the mating plug connector of the power supply facility, as the radio tag of the plug connector is thus brought within the reception range of the receiver antenna of the mating plug connector.

As mentioned above, according to the teach-in method, the requisite data for the table can thus be entered in the above-mentioned database. For example, an authorization card having a further radio tag, e.g. a further RFID tag, in particular a further NFC tag, can be applied by the user to the receiver antenna of the mating plug connector. This radio tag of the authorization card, in accordance with the function thereof, is described hereinafter as an authorization radio tag.

In one potential configuration, temporally in advance or, in a further configuration, temporally thereafter—in both configurations, preferably within a specific time interval—the plug connector of the relevant electrical device which, at this time, still assumes the “not authorized” authorization status, is plugged into the above-mentioned mating plug connector. The authorization status of the device in the database is then altered to “authorized”.

Moreover, in the same way, it is also possible for the “authorized” authorization status of an electrical device to be withdrawn again. If the authorization card is employed in the above-mentioned manner with an electrical device which carries the “authorized” authorization status, this authorization status is altered to “not authorized”.

This is advantageously achieved wherein, upon each combined employment of the authorization card with the respective electrical device, a switchover of authorization status is executed. For example, if the authorization status associated with the device ID in the power supply database is initially saved as “not authorized”, by the combined employment of the authorization card with the electrical device, the authorization status associated with the device ID in the database will be saved as “authorized”, until further notice. In the event that, thereafter, the authorization status is “not authorized”, by a further combined employment of the authorization card with the electrical device, this status can be reset to “authorized”.

By the detection of the authorization card and—in particular within the predetermined time interval—the subsequent detection of the electrical device, an assignment of the respective authorization status to the device ID can be executed in the database.

Alternatively, the method can also be modified, such that identification of the electrical device is scanned first and—preferably within the predetermined time interval—the authorization card is only scanned thereafter.

For the above-mentioned teach-in method, it is only necessary that, for the database, the relationship between the electrical device and its authorization status is detectable. This can be advantageously achieved wherein both scanning processes are executed in direct succession, i.e. the scanner device executes no other intervening scanning process. In particular, as mentioned above, between the scanning of the authorization card and the detection of the respective electrical device, a predetermined time interval can also be provided. This time interval can be limited, for example, to a maximum of 60 seconds, preferably to a maximum of 40 seconds, and particularly preferably to less than 20 seconds, in order to prevent, or at least reduce any maloperations or misclassifications.

This can be implemented, in a particularly advantageous manner, by the detection of the authorization card which is presented to the receiver antenna, on the grounds that, by this arrangement, no further operator control element, i.e. no key, or similar, is required on the plug connector and/or on the mating plug connector. This is particularly advantageous on the grounds that, in this manner, conventional proprietary plug connectors and mating plug connectors can be employed, wherein it is simply necessary for these to be provided with the above-mentioned ID radio tag or receiver antenna.

In a preferred configuration, the method can comprise the following steps:
A. Presentation of the authorization radio tag to the receiver antenna of the scanner device which is arranged in a mating plug connector of a power supply facility, wherein the mating plug connector is in an unplugged state;
B. Scanning of the authorization status modification entitlement of the radio tag of the authorization card by the scanner device, and confirmation of the authorization status modification entitlement by a database;
C. Plugging of the plug connector of the respective electrical device into the mating plug connector;
D. Scanning of the device ID of an ID radio tag of the plug connector by the scanner device, by means of the antenna thereof arranged in the mating plug connector;
E. Switchover of the existing authorization status which is initially assigned to the respective device ID in the database, namely, either from “authorized” to “not authorized”, or from “not authorized” to “authorized”;
F. Isolation or disconnection of the electrical energy supply for the authorization status assigned to the respective device ID in process step E;
   wherein the process steps can be executed in the sequence A, B, C, D, E, F, or in the sequence C, D, A, B, E, F.

In another advantageous configuration, the method can comprise the following steps:
A′. Presentation of the authorization radio tag to the receiver antenna of the scanner device which is arranged in a mating plug connector of a power supply facility, wherein the mating plug connector assumes a plugged-in state to the plug connector, and a device ID of a radio tag of the plug connector has previously been scanned by the scanner device, by means of the receiver antenna thereof;
B′. Scanning of the authorization status modification entitlement of the radio tag of the authorization card by the scanner device, and confirmation of the authorization status modification entitlement by a database;
C′. Switchover of the existing authorization status which is initially assigned to the respective device ID in the database, namely, either from “authorized” to “not authorized”, or from “not authorized” to “authorized”;
D′. Isolation or disconnection of the electrical energy supply for the electrical device by the power supply facility, according to the authorization status assigned to the respective device ID in process step C′.

In the plugged-in state of the plug connector to the mating plug connector, in all the above-mentioned methods, the present authorization status can be signaled—for example by a colored light or flashing light on the mating plug connector. This can be achieved, for example, wherein the mating plug connector comprises multi-colored LEDs.

An exemplary embodiment of the invention is represented in the drawings, and is described in greater detail hereinafter. In the drawings:

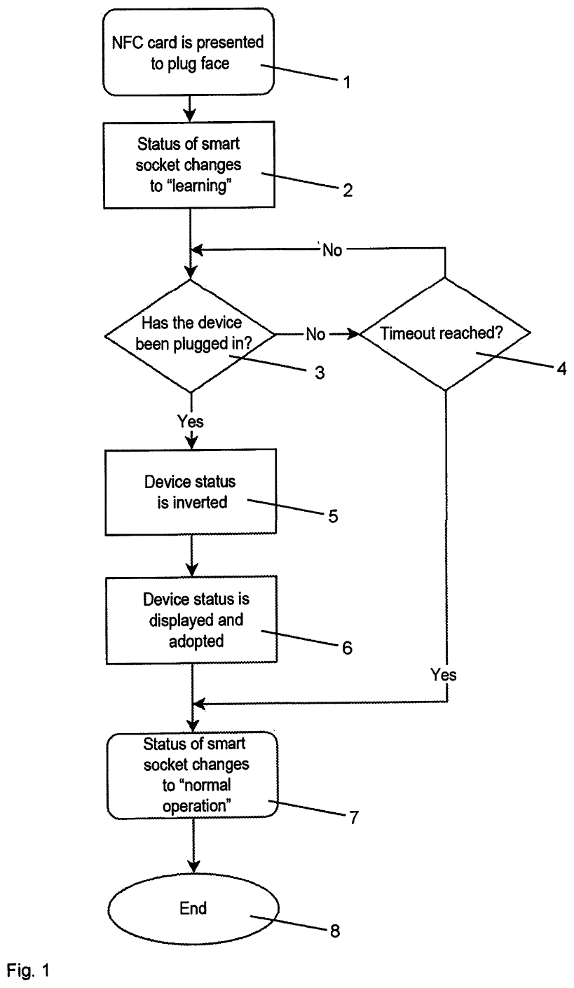

FIG. 1 shows a flow diagram of a first method;

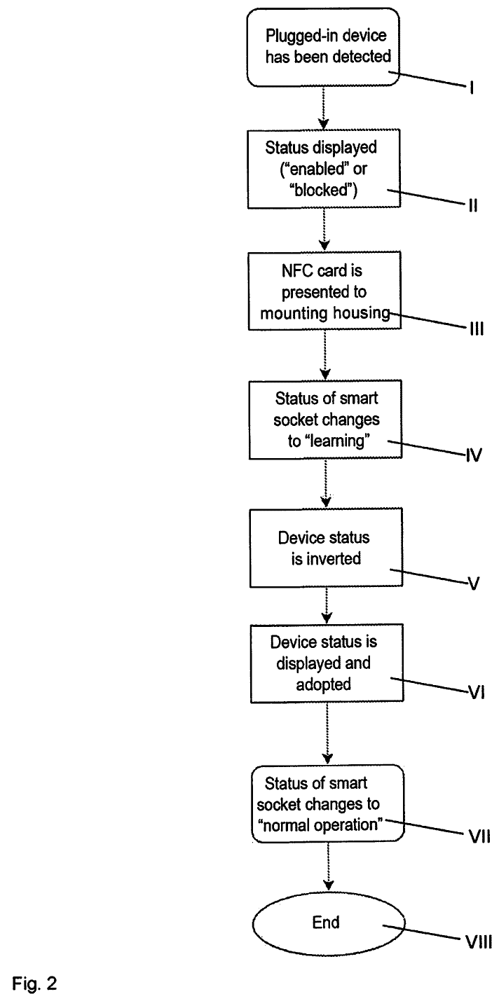

FIG. 2 shows a flow diagram of a second method.

FIG. 1 shows a first method for conferring and/or withdrawing an authorization for the supply of power to at least one electrical device on a power supply facility. The method is a teach-in method.

In a first process step 1, an authorization card in the form of a NFC card, having an authorization radio tag, is presented to the plug face of a mating plug connector, which is associated with a smart socket, i.e. with an intelligent plug connector system of the power supply facility. A NFC antenna of the NFC card is thus brought within the reception range of a NFC reader of the smart socket of the power supply facility.

In a second step 2, the status of the smart socket is switched to “learning”, i.e. for a predetermined time interval of e.g. 40 seconds or, for example, of only 20 seconds or similar, the system is receptive to teaching, and awaits the reception of a device ID from the NFC reader.

In a third step 3, a query is now executed as to whether the plug connector of an electrical device has been plugged into the mating plug connector. In the event that no device ID has been scanned within this time interval, a timeout 4 occurs. In the following process step 7, the status of the smart socket alters to “normal operation”, in which connected and authorized electrical devices are supplied with power, and electrical devices which are not authorized are not supplied with electrical energy, even if they are connected (i.e. the plug connector thereof is plugged into the mating plug connector). Thereafter, the method terminates at 8.

In the event that, conversely, within the above-mentioned time interval, the plug connector of an electrical device has been plugged into the mating plug connector, an ID radio tag of the plug connector can be scanned by the NFC reader, and the timeout 4 does not apply.

The device status, also described as the authorization status, of the relevant device, e.g. in a table of a database of the NFC reader, is now inverted, i.e. an authorization switchover is executed, namely, either from “authorized” to “not authorized”, or from “not authorized” to “authorized”. The previous authorization status (“authorized”/“not authorized”) is thus scanned, inverted (reversed) and re-entered at the same location in the table.

In this manner, using simple means, it is simultaneously possible to confirm entitlement for the conferral of authorization using the NFC card/authorization card and, at the same time, to select one of two authorization statuses which, in each case, is that status which was not previously selected. If no change is required, the process is superfluous in any event, and no employment of the authorization card is required. Advantageously, in this manner, no key or any other hardware element is required for the purposes of inputting, or similar. However, a display, e.g. an LED display, e.g. comprising various colors, e.g. red (“not authorized”), yellow (“learning”) and green (“authorized”), or flashing sequences, is advantageous.

By means of this display, in the following step 6, the new device status, also described as the authorization status of the device, can be displayed and adopted in the above-mentioned table.

In the following process step 7, the status of the smart socket changes to the above-mentioned normal operation. In the following process step 8, the method is terminated.

In FIG. 2, a second method for conferring and/or withdrawing an authorization for the supply of power to at least one electrical device on a power supply facility is illustrated, by reference to a flow diagram. This method is also a teach-in method.
I. The plug connector of the electrical device is already plugged into the mating plug connector. The electrical device has been detected, i.e. the device ID thereof has been scanned using the NFC reader.
II. The authorization status (described here as the “status”, with the additional terms “enabled” or “blocked”) of the device is displayed, for example in the above-mentioned form.
III. The authorization radio tag of a NFC card, from the exterior, is presented to a mounting housing of the mating plug connector, and is thus brought within the reception range of the NFC reader antenna/receiver antenna.
IV. The status of the smart socket changes to “learning”, i.e. the authorization status of the device ID of the presently connected electrical device can be altered.
V. In the table of the database, the device status associated with the present device ID is scanned and inverted. A status switchover is thus executed.
VI. The new device status is displayed and “adopted”, i.e. is logged in the table as an update of the authorization status which is presently associated with the device ID.
VII. The status of the smart socket changes to the above-mentioned normal operation.
VIII. The method is terminated.

### List of Reference Symbols

1-8 Process steps 1-8 of the first method
I-VIII Process steps I-VIII of the second method

1. A method for conferring and/or withdrawing an authorization for the supply of power to at least one electrical device on a power supply facility, wherein the method is a teach-in method.

2. The method as claimed in claim 1, wherein the method comprises:
an identification of the respective electrical device (3), the modification of an authorization status (5) which is associated with the device ID within a database of the power supply facility, and
checking of the entitlement for the above-mentioned modification of authorization status.

3. The method as claimed in claim 2, wherein checking of the entitlement for the above-mentioned modification of authorization status (5) is executed in combination with the above-mentioned device identification (3).

4. The method as claimed in claim 3, wherein the respective authorization status can assume exactly two states, one of which signifies an authorization for the supply of power (“authorized”), and the other of which signifies the absence of authorization for the supply of power (“not authorized”).

5. The method as claimed in claim 4, wherein the modification of authorization status is a switchover of the authorization status (5) to the respective other state (from “authorized” to “not authorized”, or from “not authorized” to “authorized”).

6. The method as claimed in claim 2, wherein confirmation of the entitlement for a modification of authorization status is executed by the scanning of an authorization radio tag (1) and device identification is executed by the scanning of a device ID of an ID radio tag (3) by means of a scanner device, via a receiver antenna.

7. The method as claimed in claim 6, wherein the two above-mentioned scanning processes (1, 3) are executed in direct succession, such that no further scanning process is temporally executed by the scanner device between the two above-mentioned scanning processes (1, 3).

8. The method as claimed in claim 7, wherein the two above-mentioned scanning processes (1, 3) are executed within a predetermined time interval (4).

9. The method as claimed in claim 8, wherein the predetermined time interval (4) is shorter than, or equal to 20 seconds.

10. The method as claimed in claim 6, wherein the method comprises the following steps:
A. Presentation of the authorization radio tag to the receiver antenna of the scanner device (1) which is arranged in a mating plug connector of a power supply facility, wherein the mating plug connector is in an unplugged state;
B. Scanning of the authorization status modification entitlement of the radio tag of the authorization card by the scanner device, and confirmation of the authorization status modification entitlement by a database (2);
C. Plugging of a plug connector of the respective electrical device into the mating plug connector (3);
D. Scanning of a device ID of an ID radio tag of the plug connector by the scanner device, by means of the antenna (3) thereof arranged in the mating plug connector;
E. Switchover of the existing authorization status which is initially assigned to the respective device ID in the database, namely, either from “authorized” to “not authorized”, or from “not authorized” to “authorized” (5);
F. Isolation or disconnection of the electrical energy supply for the electrical device by the power supply facility, according to the authorization status (7) assigned to the respective device ID in process step E;
wherein the process steps can be executed in the sequence A, B, C, D, E, F, or in the sequence C, D, A, B, E, F.

11. The method as claimed claim 6, wherein the method comprises the following steps:
A′. Presentation of the authorization radio tag (III) to the receiver antenna of the scanner device which is arranged in a mating plug connector of a power supply facility, wherein the mating plug connector assumes a plugged-in state to the plug connector, and a device ID of a radio tag of the plug connector has previously been scanned by the scanner device, by means of the receiver antenna thereof (I);
B′. Scanning of the authorization status modification entitlement of the radio tag of the authorization card by the scanner device (III), and confirmation of the authorization status modification entitlement by a database;
C′. Switchover of the existing authorization status (V) which is initially assigned to the respective device ID in the database (VI), namely, either from “authorized” to “not authorized”, or from “not authorized” to “authorized”;
D′. Isolation or disconnection of the electrical energy supply for the electrical device by the power supply facility, according to the authorization status assigned to the respective device ID in process step C′ (VII).

12. The method as claimed in-one claim 10, wherein, in the plugged-in state of the plug connector to the mating plug connector, the present authorization status is displayed (VI).

13. The method as claimed in claim 12, wherein the present authorization status is signaled by a colored light or a flashing light on the mating plug connector.

14. The method as claimed in claim 13, wherein the present authorization status is signaled on the mating plug connector by means of one or more multi-colored LEDs.
